(19) United States
(12) Patent Application Publication
(10) Pub. No.: US 2018/0276704 A1
(43) Pub. Date: Sep. 27, 2018

(54) SYSTEMS AND METHODS FOR USING INTERNET SERVICE CO-BRANDED FINANCIAL INSTRUMENTS

(71) Applicant: JPMorgan Chase Bank, N.A., New York, NY (US)

(72) Inventor: Geoffrey G. Zweig, Sammamish, WA (US)

(21) Appl. No.: 15/935,479

(22) Filed: Mar. 26, 2018

Related U.S. Application Data
(60) Provisional application No. 62/476,969, filed on Mar. 27, 2017.

(51) Int. Cl. G06Q 30/02; G06F 17/30; G06F 21/62

(52) U.S. Cl. CPC G06Q 30/0236; G06F 17/30876; G06Q 50/01; G06Q 30/0255; G06F 21/6245

(57) ABSTRACT

Systems and methods for using Internet service co-branded financial instruments are disclosed. In one embodiment, a method for using Internet co-branded financial instruments may include: (1) a financial institution and a provider of an Internet service establishing a relationship, which may be a co-branded financial instrument, such as a credit card; (2) a user receiving the co-branded financial instrument; (3) the provider of the Internet service monitoring the user's Internet service use; (4) the provider of the Internet service may provide the user's Internet service use to the financial institution; (5) the financial institution issuing rewards to the user's account based on the Internet service use; (6) the financial institution may provide the provider of the Internet service with financial information for the user; and (7) the provider of the Internet service may charge an advertiser for ad placement based on the user financial information.

### RELATED APPLICATIONS

The present application claims priority to U.S. Provisional Patent Application Ser. No. 62/476,969, filed Mar. 27, 2017, the disclosure of which is hereby incorporated, by reference, in its entirety.

In addition, the disclosures of U.S. Provisional Patent Application Ser. No. 62/352,329, filed Jun. 20, 2016, and U.S. patent application Ser. No. 15/627,678, filed Jun. 20, 2017, are hereby incorporated, by reference, in their entireties.

### BACKGROUND OF THE INVENTION

### 1. Field of the Invention

Embodiments are directed to systems and methods for using Internet service linked (e.g., co-branded) financial instruments.

### 2. Description of the Related Art

Social networks like Facebook, web portals like Yahoo, and search engines like Google and Bing monetize their services by selling ads to advertisers. The ads that are presented to a user may be based on the search history and other personal information of a user. The more accurate this information, the more valuable the advertisements.

Financial information such as that available in a user's credit card transaction history generally is not available to advertisers. Similarly, the search history and other personal information known to providers of Internet services generally is not available to financial institutions. Having this information may be helpful in the targeting of targeting financial services and products. Providing this information, however, would run counter to the privacy expectations of consumers, and result in loss of reputation and business.

### SUMMARY OF THE INVENTION

Systems and methods for using Internet service co-branded financial instruments are disclosed. In one embodiment, in an information processing apparatus for a financial institution comprising at least one computer processor, a method for rewards-based advertising may include: (1) receiving, from a provider of an Internet service, Internet use information regarding a user's use of an Internet service; (2) issuing rewards to the user's account based on the Internet use information; and (3) providing the provider of the Internet service with financial information for the user.

In one embodiment, the method may further include receiving, from the user, authorization to share the financial information for the user with the provider of the Internet service.

In one embodiment, the financial information may include financial information for an individual transaction, aggregated financial information, etc.

In one embodiment, the rewards may be issued to the user in accordance with a level of service selected by the user.

In one embodiment, the Internet use information may include Internet browsing history information for the user, posts posted by the user, social network activity Internet search information for the user, etc.

In one embodiment, the method may further include targeting an offer for a financial product to the user based on the Internet use information.

According to another embodiment, in an information processing apparatus for a financial institution comprising at least one computer processor, a method for rewards-based advertising may include: (1) receiving, from a provider of an Internet service, Internet use information regarding a user's use of an Internet service; (2) issuing rewards to the user's account based on the Internet use information; and (3) targeting an offer for a financial product to the user based on the Internet use information.

According to another embodiment, in an information processing apparatus for a provider of an Internet service comprising at least one computer processor, a method for rewards-based advertising may include: (1) providing, to a financial institution, Internet use information regarding a user's use of an Internet service; (2) receiving, from the financial institution, financial information for the user; and (3) presenting the user with an advertisement based on the financial information.

In one embodiment, the financial information may include financial information for an individual transaction, aggregated financial information, etc.

In one embodiment, the Internet use information may include Internet browsing history information for the user, posts posted by the user, social network activity Internet search information for the user, etc.

In one embodiment, the targeted advertisement may be presented to the user in the Internet service.

In one embodiment, the method may further include identifying a user interest to target; and offering advertising space in the Internet service to an advertiser based on the user interest.

In another embodiment, the method may further include identifying a user interest to target; and auctioning advertising space in the Internet service to a plurality of advertisers based on the user interest.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for using Internet service co-branded financial instruments; and

FIG. 2 depicts a method for using Internet service co-branded financial instruments.

### DETAILED DESCRIPTION OF PREFERRED EMBODIMENTS

Embodiments are directed to systems and methods for using Internet service co-branded financial instruments, such as credit cards. Embodiments may include the interchange of financial information and Internet-based activity in a transparent way that creates value for all parties involved.

As used herein, the phrase “provider of Internet services” or “Internet service provider” may refer to any entity or service that provides a service that may be accessed over the Internet. Examples include social networks (e.g., Facebook, Instagram), professional networks (e.g., LinkedIn), search engines (e.g., Google, Bing), Internet access providers (e.g., AT&T, Xfinity), etc.

In embodiments, a financial institution may offer a financial instrument, such as a co-branded credit card, with a provider of Internet services. The financial instrument may yield rewards to the user based on, for example, Internet service usage, purchases, clicks, views, etc. For example, the user may receive a reward for an activity on a social network (e.g., spending time, posting updates, liking posts, etc.), for using an Internet portal of search engine, for clicking a sponsored link, etc. Rewards may be cash-based and/or points-based, may reduce a credit card interest rate, or may offer any reward that is necessary and/or desired.

Although the disclosure may reference a co-branded financial instrument, it should be recognized that embodiments are not limited to such a financial instrument whereby a user receives rewards based on use of the financial instrument. Rather, embodiments may be based on the relationship by which a user is rewarded for permitting a financial institution and the provider of Internet services to share or exchange information about the user.

In one embodiment, the user may be informed of, and may be required to, accept terms and conditions that specify that the rewards are provided in exchange for permitting the sharing of information between, for example, a partner (e.g., a provider of Internet services); in another embodiment, the sharing may be with unspecified providers of Internet services, downstream merchants, etc.

For example, in one embodiment, the financial institution may provide summary information about the user's spending patterns, types of merchants patronized (e.g., restaurants, entertainment, travel, etc.), specific merchants, and other relevant information. The amount of information may be based on user opt-in (e.g., the user may receive different levels of rewards based on the amount of information that the user has opted-in to share), user opt-out, an arrangement between the financial institution and the partner, etc.

In one embodiment, the financial institution may share high-level transaction information (e.g., average monthly spend, top ten types of merchants, average credit card balance, etc.), more detailed information (e.g., monthly number of transactions over $50, top ten merchant identities, types of merchants patronized (e.g., luxury, travel, etc.), credit limit, level of debt, etc.), etc. Any number of levels, and/or the type and amount of information that may be provided in the levels, may be used as is necessary and/or desired.

In one embodiment, the information may be provided periodically (e.g., daily, monthly, etc.), when the user logs into his or her account, or at any other time as necessary and/or desired.

In one embodiment, the provider of the Internet service may make the information available to advertisers in a bidding process, thus increasing the value of the Internet service.

In another embodiment, the provider of the Internet service may present advertisements, offers, etc. to customers based on the financial institution information without providing customer information to the advertiser. For example, the provider of the Internet service may offer space for a restaurant ad for customers that have financial information indicating that they dine out often.

Thus, the provider of the Internet service may be able to better target advertisements from its advertisers, making its service more valuable. Advertisers may target more specific categories of people based on actual financial and/or transaction histories.

In one embodiment, the user's Internet use (e.g., searches, browsing history, behavior, online purchases, electronic wallet use, etc.) may be provided to the financial institution by the provider of the Internet service. The user may receive rewards, offers, etc. for allowing the provider of the Internet service to share this information. In one embodiment, the user's Internet service use may be collected automatically by the provider of the Internet service (e.g., based on time tracked using an app, a number of searches recorded when logged on to portal or search engine, etc.) and may be provided to the financial institution periodically (e.g., daily, weekly, monthly), on demand, etc. By explicitly linking a financial instrument, or a rewards program, to a provider of an Internet service, an expectation of information-sharing is created, thus making the consumer comfortable with the information sharing.

In one embodiment, the financial institution may offer products (e.g., financial products) and/or services to a customer based on the customer's Internet information. For example, if a customer has a browsing history that indicates that the customer may be purchasing a house, the financial institution may offer realtor information, mortgage products, moving services, technical services (e.g., Internet, telephone, television, etc.) etc. to the customer. These services may be provided by partners of the financial institution.

In one embodiment, the services may be offered to the customer by mail, by e-mail, by phone, by SMS/text messaging, at an ATM, through a financial institutions computer application, by mail, or by any other channel as is necessary and/or desired.

Thus, financial institutions may receive periodic information about the search patterns and/or social network activity of its customers, and may target offers to its customers based on this information. Users may earn rewards in return for sharing information.

In one embodiment, the information that is provided by the financial institution may have some or all personal identifiable information (“PII”) removed, and information may instead be provided by demographics. In one embodiment, PII may be provided to the provider of Internet services, but the provider of Internet services may be contractually-restricted from providing the information to its advertisers. Any suitable arrangement may be used as is necessary and/or desired.

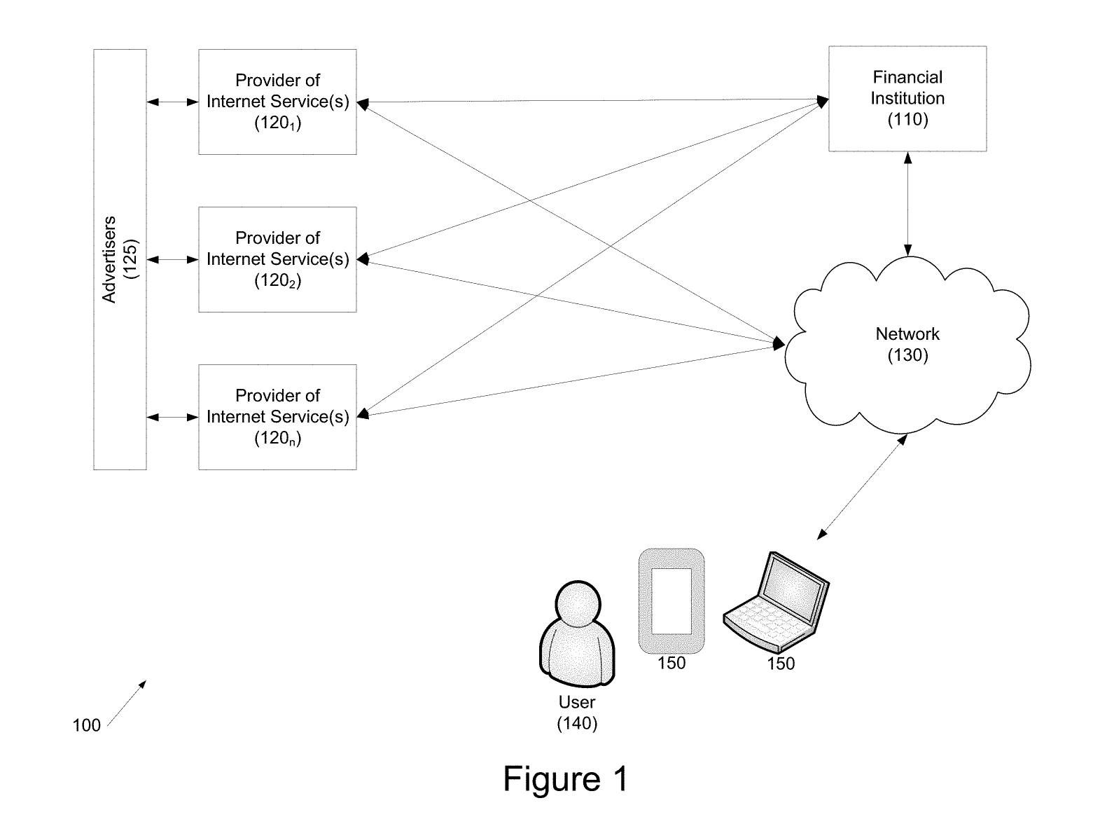

Referring to FIG. 1, a system for using Internet service co-branded financial instruments is disclosed according to one embodiment. System 100 may include, for example, financial institution 110, one or more provider of Internet service 120, network(s) 130, and user 140. In one embodiment, user 140 may use one or more electronic device 150, such as a smartphone, tablet computer, notebook computer, desktop computer, Internet of Things (“IoT”) appliance, etc.

In one embodiment, financial institution 110 may include any financial institution with which user 140 may have an account. Examples include credit card issuers, banks, lenders, etc.

In one embodiment, provider of Internet service 120 may include any entity that may provide an Internet-based service that may be trackable by time, by accesses, by clicks, by searches, etc. This may include, for example, social networks (e.g., Facebook, LinkedIn, etc.), Internet Portals (e.g., Yahoo), Internet search engines (e.g., Microsoft, Google), Internet service providers (e.g., Verizon, AT&T, Comcast), etc. Any other type of provider 120 may be included as is necessary and/or desired.

In one embodiment, provider 120 may provide advertisements and/or offers to user 140. In one embodiment, provider 120 may interact with advertiser(s) 125 to identify and target ads to user 140.

In FIG. 1, three providers 120 and one advertiser 125 are depicted. It should be recognized, however, that a greater or fewer number of providers 120 and/or advertisers 125 may be provided as is necessary and/or desired. In addition, financial institution 110 may provider offers to user 140 based on, for example, the Internet service. For example, these offers and advertisements may be provided from financial institution 110 and providers 120/advertisers 125, respectively, to user 140 via network 130.

In one embodiment, the trackable service may be based on time spent using the Internet service, queries provided to the service, links provided by the provider of the Internet service that were clicked, ad(s) that were clicked by the user, views of links provided by the provider of the Internet service, etc.

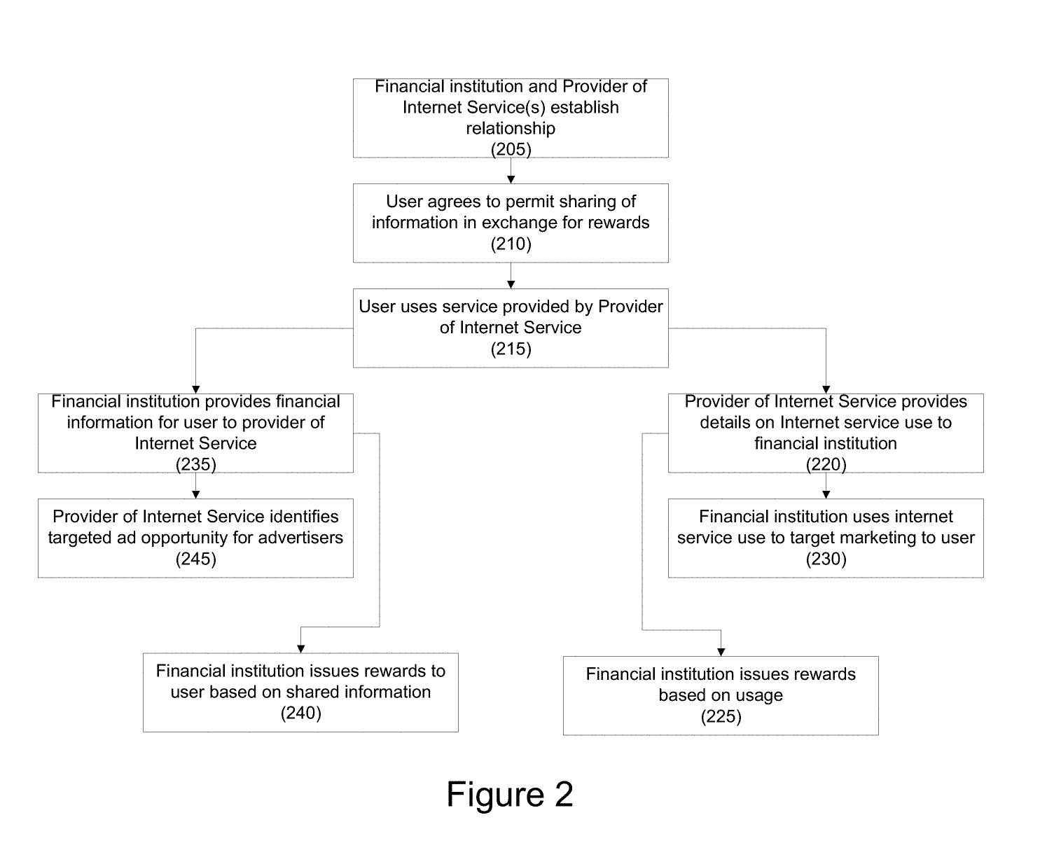

Referring to FIG. 2, a method for using Internet service co-branded financial instruments is provided. In step 205, a financial institution and a provider of an Internet service may establish a relationship. In one embodiment, this may include a relationship based on a linked co-branded financial instrument, such as a credit card, based on a rewards account, etc.

It should be noted that the flow depicted in FIG. 2 may include steps that may be performed in parallel, in different orders, etc.

In another embodiment, the financial institution and one or more provider of the Internet service(s) may establish terms, conditions, and payment for the exchange of information. For example, the provider of the Internet service may pay for certain financial information from the financial institution, such as customer information (e.g., name, address, account information, transaction information, etc.), and the financial institution may pay for certain Internet information from the provider of the Internet service (e.g., browsing history, clicks, etc.).

In step 210, the user may agree to release or share a certain amount of financial information to one or more provider of Internet service(s), and/or to release a certain amount of Internet-use information to one or more provider of Internet service(s), in exchange for rewards, discounts, etc.

In one embodiment, the user may be rewarded using, for example, a financial instrument that may receive the rewards, compensation, or other benefits. In one embodiment, the financial instrument may be a linked, or co-branded financial instrument. In another embodiment, the user may be rewarded by having “points” or similar deposited into a rewards account for the user. In still another embodiment, the user may be rewarded by receiving one or more discounts (e.g., discounted fees the provider of Internet services, the financial institution, a partner of either, etc.).

In one embodiment, the user may select a rewards level. The rewards level may be based on, for example, the amount of data that the user allows the financial institution to share with the provider of the Internet service(s), and/or the amount of information that the provider of the Internet service(s) is allowed to share with the financial institution. For example, if the user agrees to provide access to his or her Internet browsing history, the user may be credited with a certain amount of reward points or dollars, discounts, credits, etc. As another example, if the user agrees to release only high-level information (e.g., number of transactions at restaurants), the user may receive fewer rewards, compensation, or other benefits than if the user released more detailed information (e.g., identification of merchants, dollar amounts of transactions, etc.).

In step 215, the user may use the service(s) provided by the provider of Internet services, and the provider of the Internet service(s) may monitor the user's Internet service use. For example, the provider of the Internet service may track the time the user spends using the provider's software application, computer program, Internet portal, website, etc., a number of searchers performed using the provider of the Internet service's search engine, a number of advertiser-sponsored links that the user follows, etc. In one embodiment, the provider may access the user's Internet browsing history and download the user's activity.

In step 220, the provider of the Internet service may provide information regarding the user's Internet service use to the financial institution. In one embodiment, this may be provided periodically (e.g. daily, weekly, monthly, per billing statement, etc.) or as necessary and/or desired. In one embodiment, the amount of information provided may depend on the level of information authorized to be released by the user.

For example, the information may be collected by recording the websites that the user visits, summarizing the web pages, summarizing the posts the user “likes,” analyzing the text of user posts on social networking sites (e.g., Facebook, LinkedIn, etc.), etc. In one embodiment, social graphs and networking may be accessed and summarized along with information regarding the user's contacts.

In step 225, the financial institution may process the information regarding the user's Internet service use, and may issue rewards, credits, discounts, etc. to the user's account. In one embodiment, this may involve determining a rewards level selected by the user, and issuing the rewards, credits, or discounts in accordance with the selected rewards level.

In step 230, the financial institution may use the Internet service information to target marketing to the user, to better know the customer, or as necessary and/or desired. For example, if the user's browsing history indicates that the user has been researching mortgage rates, the financial institution may provide information about its mortgage products to the user. This may be provided in the financial institution's mobile application, at its website, by SMS, or any suitable method as is necessary and/or desired.

In one embodiment, the financial institution may identify targeted marketing opportunities based on, for example, the user's social media posts, the websites that the user visited, etc. For example, if the user has made posts regarding a home renovation, the user may be offered a home equity line of credit.

In step 235, the financial institution may provide the provider of the Internet service with financial information for the user. In one embodiment, this may be provided periodically (e.g. daily, weekly, monthly, per billing statement, etc.) or as necessary and/or desired. The provider of the Internet service may then provide or sell this information to advertisers, or use it for any suitable purpose.

In one embodiment, the amount of financial information that is provided may vary, for example, based on the rewards level selected by the user. For example, in one embodiment, the user may permit the disclosure of the types of accounts (e.g., credit card, deposit, savings, home equity, etc.) that the user has. In another embodiment, the information may be aggregated; for example, the information about the user (e.g., total inflows/outflows), by category (e.g., spend on gas, groceries, restaurants, etc.); at a transaction-level, etc.

In step 240, the financial institution may issue rewards, credits, discounts, etc. to the user's account based on the information that was shared with the provider of Internet services. In one embodiment, this may involve determining a rewards level selected by the user, and issuing the rewards, credits, or discounts in accordance with the selected rewards level.

In one embodiment, separate rewards may be provided by the provider of the Internet service and the financial institution. For example, the provider may provide rewards based on user of Internet services, but may not link it to a financial institution (e.g., the provider may reward users that use the service, make posts, write reviews, etc.)

In step 245, the provider of the Internet service may identify an opportunity to target an ad to the customer based on the information received from the financial institution. In one embodiment, the financial institution may provide a targeted ad to the user as part of the service(s) that it provides, by a different channel (e.g., SMS, email, mail, etc.), or as otherwise necessary and/or desired.

In one embodiment, the provider of the Internet services may auction ad space to advertisers based on an identified targeting opportunity. An ad from the highest bidding advertiser may be selected for presentation to the user.

In one embodiment, the provider of the Internet services may provide some or all financial information to a downstream merchant, advertiser, etc. This may be restricted, for example, by an agreement between the financial institution, the provider, and the user (e.g., can only use the data for X number of advertisements, can only use shared data for Y period of time, etc.).

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for rewards-based advertising, comprising:
in an information processing apparatus for a financial institution comprising at least one computer processor:
receiving, from a provider of an Internet service, Internet use information regarding a user's use of an Internet service;
issuing rewards to the user's account based on the Internet use information; and
providing the provider of the Internet service with financial information for the user.

2. The method of claim 1, further comprising:
receiving, from the user, authorization to share the financial information for the user with the provider of the Internet service.

3. The method of claim 2, wherein the financial information comprises financial information for an individual transaction.

4. The method of claim 2, wherein the financial information comprises aggregated financial information.

5. The method of claim 1, wherein the rewards are issued to the user in accordance with a level of service selected by the user.

6. The method of claim 1, wherein the Internet use information comprises Internet browsing history information for the user.

7. The method of claim 1, wherein the Internet use information comprises posts posted by the user.

8. The method of claim 1, wherein the Internet use information comprises social network activity for the user.

9. The method of claim 1, wherein the Internet use information comprises Internet search information for the user.

10. A method for rewards-based advertising, comprising:
in an information processing apparatus for a financial institution comprising at least one computer processor:
receiving, from a provider of an Internet service, Internet use information regarding a user's use of an Internet service;
issuing rewards to the user's account based on the Internet use information; and
targeting an offer for a financial product to the user based on the Internet use information.

11. A method for rewards-based advertising, comprising:
in an information processing apparatus for a provider of an Internet service comprising at least one computer processor:
providing, to a financial institution, Internet use information regarding a user's use of an Internet service;
receiving, from the financial institution, financial information for the user;
presenting the user with an advertisement based on the financial information.

12. The method of claim 11, wherein the financial information comprises financial information for an individual transaction.

13. The method of claim 11, wherein the financial information comprises aggregated financial information.

14. The method of claim 11, wherein the Internet use information comprises Internet browsing history information for the user.

15. The method of claim 11, wherein the Internet use information comprises posts posted by the user.

16. The method of claim 11, wherein the Internet use information comprises social network activity for the user.

17. The method of claim 11, wherein the Internet use information comprises Internet search information for the user.

18. The method of claim 11, wherein the targeted advertisement is presented to the user in the Internet service.

19. The method of claim 11, further comprising:
identifying a user interest to target; and
offering advertising space in the Internet service to an advertiser based on the user interest.

20. The method of claim 11, further comprising:
identifying a user interest to target; and
auctioning advertising space in the Internet service to a plurality of advertisers based on the user interest.
